(19) United States
(12) Patent Application Publication
(10) Pub. No.: US 2012/0306827 A1
(43) Pub. Date: Dec. 6, 2012

(54) DISPLAY DEVICE

(75) Inventor: Yoshiharu OWAKU, Mobara (JP)

(73) Assignee: Hitachi Displays, Ltd.

(21) Appl. No.: 13/483,106

(22) Filed: May 30, 2012

(30) Foreign Application Priority Data
Jun. 2, 2011 (JP) 2011-124674

(51) Int. Cl. G09G 5/00

(52) U.S. Cl. 345/204

(57) ABSTRACT

One embodiment of the present invention discloses a display device including a plurality of data lines supplied with potentials via a data driver, a plurality of gate lines supplied with a potential via a gate driver, and a display part which includes a pixel element corresponding to an intersection point of one of the plurality of data lines and one of the plurality of gate lines on a substrate. The pixel element includes a substrate connection part formed on the substrate; a shutter formed above the substrate, the shutter including a light blocking part, the shutter being formed above the substrate, and a beam which connects the substrate connection part and a side surface of the light blocking part; and an electrode formed on the substrate, the electrode being opposite to and separated from an exterior edge of the side surface of the shutter.

### CROSS REFERENCE TO RELATED APPLICATIONS

This application is based upon and claims the benefit of priority from the prior Japanese Patent Application No. 2011-124674, filed on Jun. 2, 2011; the entire contents of which are incorporated herein by reference.

### BACKGROUND OF THE INVENTION

1. Field of the Invention

The present invention is related to a device which displays an image etc. In particular, the present invention is related to a device which displays an image etc. by adjusting the amount of light which passes through each pixel element corresponding to a pixel.

2. Description of the Related Art

A display device which uses liquid crystals is known as a device which displays an image etc. In this type of device, the amount of light which passes through a polarization plate is controlled for each pixel by controlling the polarization of light which passes through the liquid crystals sandwiched between electrodes. Here the polarization plate is arranged at a position of the liquid crystals corresponding to a pixel.

However, a display device which uses liquid crystals requires time to change the polarization of light which passes through the liquid crystals. As a result, when displaying an image etc. which changes at high speed, there is a problem in that viewers often recognize a residual image. In addition, because it is necessary to pass light through multiple layers such as a polarization plate, a liquid crystal layer, a color filter, an electrode, etc., the usage efficiency of the light decreases and it is difficult to obtain a bright display.

On the other hand, in recent years, display devices with mechanical shutters (hereinafter referred to as “MEMS shutters”), which are manufactured with MEMS (Micro Electro Mechanical Systems) technology, are gathering attention. A display device which uses MEMS shutters (hereinafter referred to as “a MEMS display device”) controls the amount of light which passes through each shutter on each pixel by rapidly opening and closing and thereby the brightness of an image is adjusted.

A time-ratio-scale method is adopted in the MEMS display device whereby an image is displayed by switching red, green, and blue light from an LED backlight in sequence. The MEMS display device does not require a polarization film or a color filter which are used in liquid crystal display devices and is characterized by having around ten times the usage efficiency of backlight light and half or less the power consumption compared to liquid crystal display devices and also has excellent color reproducibility. In addition, a MEMS display device can change the display of an image etc. at high speed.

For example, a display device is disclosed in Japanese Patent Laid Open 2008-197668 as an example of a MEMS display device in which a shutter which moves in a parallel direction to a substrate is arranged on each pixel. In such a display device, a compliant road beam which opposes a drive beam is connected on one surface in the movement direction of the shutter, a spring beam is connected on the other surface, a voltage is applied between the compliant road beam and the drive beam, and the amount of light which passes through is controlled whereby the shutter is moved.

### BRIEF SUMMARY OF THE INVENTION

However, in the display device disclosed in the above mentioned laid open, because the compliant road beam and drive beam are mechanically in contact it is necessary to insulate the compliant road beam and drive beam. As a result, it is necessary to form an insulation film on a side surface of the compliant road beam and a side surface of the drive beam. In addition, because the compliant road beam and the drive beam are mechanically in contact, the beams themselves deteriorate and the insulation films formed on the beams also deteriorate.

Therefore, a display device which moves a shutter without generating mechanical contact and controls the amount of light which passes through is provided as one embodiment of the present invention.

That is, a display device is provided as one embodiment of the present invention including a plurality of data lines supplied with potentials via a data driver, a plurality of gate lines supplied with a potential via a gate driver; and a display part which includes a pixel element corresponding to an intersection of a data line and a gate line on a substrate. The pixel element is arranged with a substrate connection part formed on the substrate, a shutter being formed above the substrate, a beam which connects the substrate connection part, a side surface of the light blocking part, and an electrode formed on the substrate separated from an exterior edge formed on an opposite side of the side surface of the shutter.

In addition, a display device is provided as one embodiment of the present invention in which the pixel element further includes a second electrode formed on the substrate, a part of the second electrode opposing another part of the exterior edge.

In addition, a display device is provided as one embodiment of the present invention including a plurality of data lines supplied with potentials via a data driver, a plurality of gate lines supplied with a potential via a gate driver, and a display part which includes a pixel element, the pixel element corresponding to an intersection of a data lines and a gate line on a substrate, wherein each of the pixel elements is arranged with a substrate connection part formed on the substrate; a shutter formed above the substrate, the shutter including a light blocking element, a first side surface, and an exterior edge arranged on an opposite side to the first side surface; a beam which connects the substrate connection part and a side surface of the light blocking part; and a plurality of electrodes formed on the substrate separated from the exterior edge.

### BRIEF DESCRIPTION OF THE DRAWINGS

FIG. 1 shows a functional block view, a perspective view, and a upper surface view of a display device related to one embodiment of the present invention,

FIG. 2 shows an upper surface view and a side surface view of a mechanical shutter of a display device related to one embodiment of the present invention,

FIG. 3 shows a diagram which explains a movement of a mechanical shutter of a display device related to one embodiment of the present invention,

FIG. 4 shows an upper surface view of the mechanical shutter of a display device related to one embodiment of the present invention,

FIG. 5 shows a diagram which explains a movement of a mechanical shutter of a display device related to one embodiment of the present invention,

FIG. 6 shows an upper surface view of the mechanical shutter of a display device related to one embodiment of the present invention,

FIG. 7 shows a diagram which explains a movement of a mechanical shutter of a display device related to one embodiment of the present invention,

FIG. 8 shows an upper surface view of the mechanical shutter of a display device related to one embodiment of the present invention, and

FIG. 9 shows a diagram which explains a movement of a mechanical shutter of a display device related to one embodiment of the present invention.

### DETAILED DESCRIPTION OF THE INVENTION

A display device related to the present invention is explained below in a plurality of embodiments. Furthermore, the present invention is not limited to these embodiments and can be performed by making various modifications in the embodiments. In addition, some film thicknesses or some distances between structural elements etc. in the drawings may be exaggerated and shown differently to actual components.

### Embodiment One

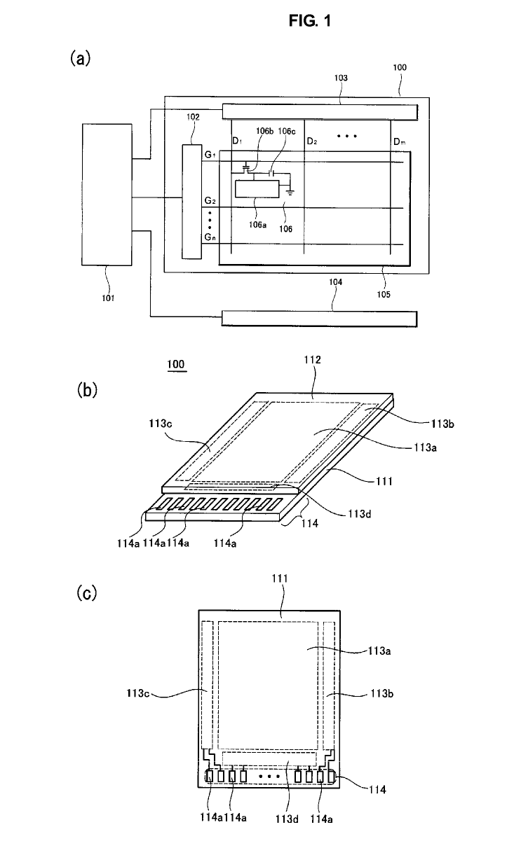

A functional block diagram of a display device related to the present embodiment is shown in FIG. 1 (a). A perspective view diagram of the display device related to the present embodiment is shown in FIG. 1 (b). In addition, a planar view diagram of the display device of the present invention related to the present embodiment is shown in FIG. 1 (c).

Referring to FIG. 1 (a), the display device 100 includes a controller 101, a gate driver 102, a data driver 103, a back light part 104, and a display part 105.

The controller 101 receives an image signal. In order to display an image representing the image signal, the controller 101 determines a scanning line for display and after determining the brightness of pixels on the scanning line supplies a signal representing the brightness of the pixels on the scanning line to the data drier 103 and supplies a signal representing the scanning line determined by the gate driver 102. Furthermore, the controller 101 controls the production of each RGB light respectively from the backlight part 104. The light produced by the backlight part 104 can pass through the display part 105. As explained below the amount of light which passes through the display part 105 is controlled by a mechanical shutter 106a of a pixel 106.

The gate driver 102 selects the gate line corresponding to the scanning line determined by the controller 101 and supplies a potential to the selected gate line.

The gate driver 103 supplies potentials corresponding to the brightness of pixels on the data lines on the scanning line determined by the controller 101.

The display part is arranged with a plurality of gate lines G1, G2, . . . , Gn and a plurality of data lines D1, D2, . . . , Dm. The plurality of gate lines G1, G2, . . . , Gn and the plurality of data lines D1, D2, . . . , Dm alternately intersect each other. A pixel 106 is arranged at each intersection point of one of the plurality of gate lines G1, G2, . . . , Gn and one of the plurality of data lines D1, D2, . . . , Dm. A mechanical shutter 106a and a switching element 106b are arranged on the pixel 106.

The mechanical shutter 106a controls the amount of light which passes through an aperture part of the display part 106 corresponding to a pixel 106. The structure of the mechanical shutter 106a related to the present embodiment is explained below.

The switching element 106b controls transfer of a voltage supplied to the data line to the mechanical shutter 106a. The switching element 106b is a transistor such as a thin film transistor. In FIG. 1(a), a gate electrode of the transistor is connected to a gate line, either a drain electrode or a gate electrode of the transistor is connected to a data line, and the other is connected to the mechanical shutter 106a and a condenser 106c. In this way, if the switching element is in an ON state due to a potential supplied to the gate line selected by the gate driver 102, a potential supplied to the data line by the data driver 103 is applied to the mechanical shutter 106a and the condenser 106c.

The condenser 106c continues to supply a potential to the mechanical shutter 106c even while the gate line is not selected by the gate driver 102.

Referring to FIG. 1 (b) and FIG. 1 (c), the display device 100 of the present invention related to the present embodiment includes a substrate 111 and an opposing substrate 112. The substrate 111 includes a display part 113a, a terminal part 114 which includes drive circuits 113b, 113c and 113d, and a plurality of terminals 114a.

The display part 113a includes a plurality of pixels 106 arranged in a matrix and a pixel includes a mechanical shutter 106a, a switching element 106b and a condenser 106c. The drive circuits 113b and 113c are data drivers 103. The drive circuits 113b and 113c supply a data signal to the switching elements 106b. A drive circuit 113d is the gate driver 102 and the drive circuit 113d supplies a data signal to the switching elements 106b. Furthermore, in FIG. 1 (b) and (c), the drive circuits 113b and 113d which are data drivers are arranged so as to sandwich the display part 113. However, the present invention is not limited to this structure.

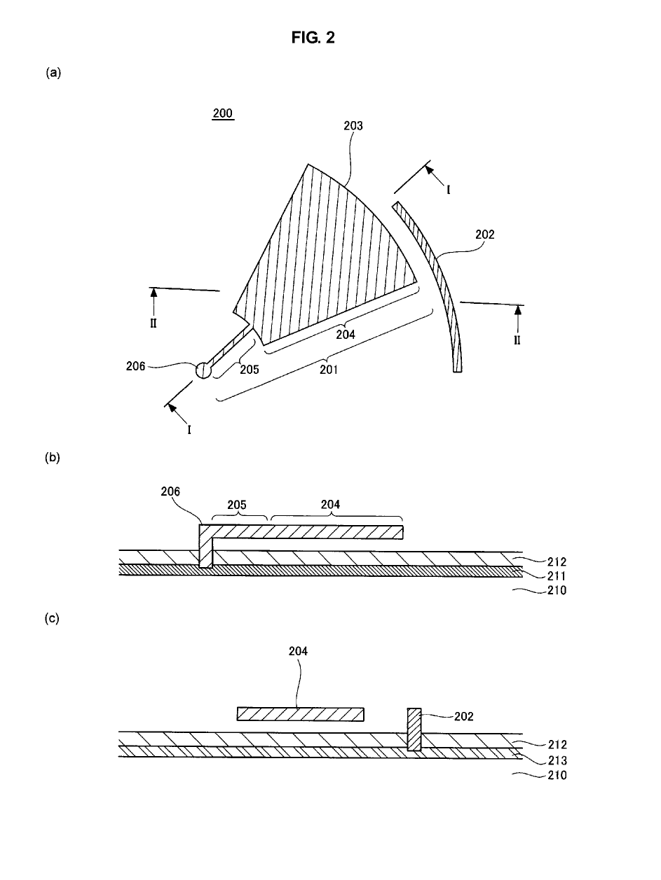

In FIG. 2, an upper surface view (FIG. 2 (a)) and a cross sectional views (FIG. 2 (b) and FIG. 2 (c)) of a mechanical shutter placed corresponding to a pixel 106 of a display device related to the present embodiment are shown.

Referring to FIG. 2 (a), the mechanical shutter 200 includes a movable part 201 and a fixed electrode 202. The movable part 201 is arranged with a shutter 204, a beam 205, and a substrate connection part 206.

The shutter 204 is formed from a material which does not allow light to pass through. In addition, the shutter 204 is formed parallel to the substrate of the display part 105. The shutter 204 has a shape in which a section that is closer to the center of a circle than the arc of the circle is removed from a shape enclosed by the two radiuses of the circles (in other words a fan shape) as is shown in FIG. 2 (a) and the other diagrams. In addition, the beam 205 is formed on a side surface of the side which appears after the removal of the section. Furthermore, the shape of the shutter 204 is not limited to the shape shown in FIG. 2 (a) and the other diagrams. It is possible to use any shape for the shutter 204. However, the exterior edge part 203 of the shutter 204 is preferred to have a round arc shape or roughly round arch shape. Due to this round arc shape or roughly round arch shape, when the shutter 204 is moved in parallel to the substrate of the display part 105, the fixed electrode 202 and the shutter 204 are prevented from contacting as is explained below. However, the shape of the exterior edge part 203 of the shutter 204 is not limited to a round arc shape or roughly a round arc shape. The shape of the exterior edge part 203 of the shutter 204 may also be formed with bent lines or one or more of curved lines.

The beam 205 connects the shutter 204 and the substrate connection part 206. The beam 205 is preferred to have a shape which can bow and be deformed. That is, it is preferred that the beam 205 have a shape which can undergo deformation so that it is possible to move the shutter 204 in a parallel direction to the substrate of the display part 105. For example, as is shown in FIG. 2 (a), the beam 205 has a shape in which the width is narrower than the shutter 204, a plate shape, for example, in the case of observing from the upper surface of the substrate of the display part 105.

The substrate connection part 206 is the part formed by connecting to the substrate of the display part 105. The substrate connection part 206 is a part for holding the shutter 204 away from the surface of the substrate 111 of the display part 105 via the beam 205. In addition, the substrate connection part 206 may be able to be deformed by being twisted according to the movement of the shutter 204 in the case where the shutter 204 moves in a horizontal direction with respect to the top of the substrate 111. In this way, it is possible to reduce the size of the transformation of the beam 205. In addition, it is possible to prevent damage to the beam due to deformation. Alternatively, it is possible to ensure that the amount of movement of the shutter 204 becomes larger due to the deformation of the substrate connection part 206 in addition to the deformation of the beam 205.

Furthermore, the substrate connection part 206 and the exterior edge part 203 are electrically connected via the beam 205 and the shutter 204. Because of this, the movable part 201 is formed using a conductive material such as amorphous silicon etc.

The fixed electrode 202 is an electrode formed on the substrate of the display part 105. The fixed electrode 202 is shown with a roughly round arc shape in FIG. 2 (a). That is, the fixed electrode 202 is formed along a round arc with a radius larger than the radius of the round arc which is the shape of the exterior edge of the shutter. However, the shape of the fixed electrode 202 is not limited to a roughly round arc. The fixed electrode 202 may have a shape whereby the exterior edge 203 and the fixed electrode 202 do not contact when the shutter 204 moves in a horizontal direction with respect to that substrate of the display part 105 due to the deformation of the beam 205 and/or the substrate connection part 206. In addition, in the case of a shape whereby the beam 205 and the substrate connection part 206 do not undergo deformation, a part of the exterior edge part 203 and a part of the fixed electrode 202 oppose each other at a certain distance so that these parts are separated. Furthermore, when the beam 205 and the substrate connection part 206 are not deformed, the fixed electrode 202 includes a part which does not face a part of the exterior edge part 203.

A cross sectional view along the line I-I in FIG. 2 (a) is shown in FIG. 2 (b). As is shown in FIG. 2 (b), wiring 211 is formed above the substrate 210 of the display part. In addition, the wiring 211 is connected to the substrate connection part 206. With this structure, it is possible to supply a potential to the movable part 201. In addition, a protective film or an insulation film 212 may be formed above the substrate 210 and wiring 211 according to necessity.

A cross sectional view along the line II-II in FIG. 2 (a) is shown in FIG. 2 (c). As is shown in FIG. 2 (c), the wiring 213 different to the wiring 211 is formed above the substrate 210. In addition, the wiring 213 is connected to the fixed electrode 202. It is possible to supply a different potential from the potential supplied to the exterior edge part 203 to the fixed electrode 202 by having different wiring 211 and 213.

The potential of the wiring 211 is maintained at a ground potential by connecting the wiring 211 to a common electrode of the display part 105. In addition, by connecting the wiring 213 to a data line via the switching element 106b, a potential supplied to the data line is supplied to the wiring 213 according to a selection of the gate line by the gate driver 102. Alternatively, the wiring 211 may be connected to the data line via the switching element 106b and the wiring 213 may be connected to the common electrode of the display part 105.

Furthermore, the following can be given as an example of a formation method of the mechanical shutter related to the present embodiment. That is, the wiring 211 and the wiring 213 are formed above the substrate 111 of the display part 105 and the insulation film 212 is further formed according to necessity.

Next, a photo resist, which becomes a sacrifice layer, is stacked and following this and the photo resist is patterned into the shape of a support part of the substrate connection part 206 and the fixed electrode 206. A material of the substrate connection part 206 (amorphous silicon for example) is formed as a layer above the patterned photo resist. Following this, etching of the sacrifice layer is performed and the support part of the substrate connection part 206 and the fixed electrode 202 is formed.

Furthermore, as described above, a photo resist (that is, a sacrifice layer) is formed and following this, the photo resist is patterned into a shape of the beam 205, the shutter 204, and an electrode part of the fixed electrode 202. A material (amorphous silicon for example) of the shutter 204 and the beam 205 is formed an upper layer of patterned photo resist and following this the sacrifice layer is etched and the beam 205, the shutter 204, and the electrode part of the fixed electrode 202 are formed.

Furthermore, the sacrifice later may be removed in one batch by etching after the substrate connection part 206, the support part of the fixed electrode 202, the beams 205, the shutter 204, and the electrode part of the fixed electrode 202 are formed in one batch.

In addition, a film may be formed above the shutter 204 using a metal layer material such as aluminum etc. in order to improve light blocking capabilities of the shutter 204.

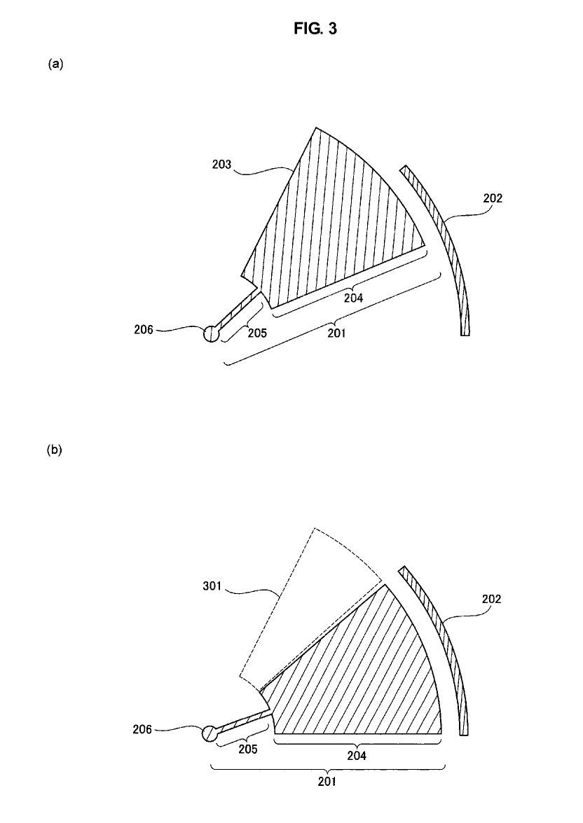

FIG. 3 explains the movement of the mechanical shutter 2000 related to the present embodiment. FIG. 3 (a) shows the case where the potential supplied to the movable part 201 and the potential supplied to the fixed electrode 202 are roughly the same. In this case, the beam 205 and the substrate connection part 206 are not deformed. As a result, the relative positional relationship between the movable part 201 and the fixed electrode 202 becomes the same as that shown in FIG. 2.

FIG. 3 (b) shows the case where the potential supplied to the exterior edge part 203 and the potential supplied to the fixed electrode in the state shown in FIG. 3 (a) becomes different. For example, a ground potential is supplied to the movable part 201 and a potential of a data line supplied via the switching element 106b is supplied to the fixed electrode 202. Then, an electrical attraction force (electrostatic force) which attracts the shutter 204 to the fixed electrode 202 is generated and the shutter 204 deforms the beam 205 and/or the substrate connection part 206. As a result, the shutter 204 moves in an anti-clockwise direction in FIG. 3 (a) with the substrate connection part 206 as the center. Following this, the shutter 204 stops at a position where the electrical attraction force and the force which attempts to restore to a state where the beam 205 and substrate connection part 206 are not deformed, are balanced.

Therefore, seen from the uppers surface of the substrate 210, the aperture part 301 can be arranged as follows. That is, it is possible to arrange an aperture part 301 at a part of the substrate 111 of the display part 105 which is covered by the shutter 204 in the state shown in FIG. 3 (a), and at a part of the substrate 111 of the display part 105 which is not covered by the shutter 204 in the state shown in FIG. 3 (b). In the case where light produced by the back light part 104 passes through the aperture part 301, it is possible to control the amount of light which passes through to each pixel by controlling the potential supplied to the exterior edge part 203 and the potential supplied to the fixed electrode 202.

As described above, in the present embodiment, it is possible to control a potential supplied to the exterior edge part 203 and a potential supplied to the fixed electrode 202, transit between a state where the beam 205 and/or substrate connection part 206 undergo deformation and a state where the beam 205 and/or substrate connection part 206 do not undergo deformation, and ensure that the movable part 201 and the fixed electrode 202 do not contact. In this way, it is possible to prevent the movable part 201 and the fixed electrode 202 from deteriorating, it is no longer necessary to form an insulation film on the exterior edge part 203 and the side surface of the fixed electrode 202, and the manufacturing process becomes simplified. In particular, a process for arranging an aperture on an insulation film formed on the terminal 114a is no longer necessary.

Because the amount of light which passes through the aperture part 301 is controlled per unit of time by controlling the length of time during which a potential difference is produced between the exterior edge part 203 and the fixed electrode 202, it is possible to make a person viewing the display part 105 recognize as if the brightness of an image is being controlled.

Furthermore, the larger the difference between the potential supplied to the exterior edge part 203 and the potential supplied to the fixed electrode 202, the larger the electrical attraction force which attracts the shutter 204 to the fixed electrode 202 and thereby the amount of transmittance light can be controlled by controlling the difference between the potential supplied to the exterior edge part 203 and the potential supplied to the fixed electrode 202.

Furthermore, when the display part 105 is filled with oil according to necessity, electrostatic capacitance of a condenser, which is formed with the exterior edge part 202 and the fixed electrode 202, increases. In this way, it is possible to increase the electrical attraction force which attracts the shutter 204 to the fixed electrode 202 and thereby it is possible to realize a shutter which can open and close more rapidly.

### Embodiment Two

A structure of a mechanical shutter which uses a plurality of fixed electrodes is disclosed as embodiment two of the present invention.

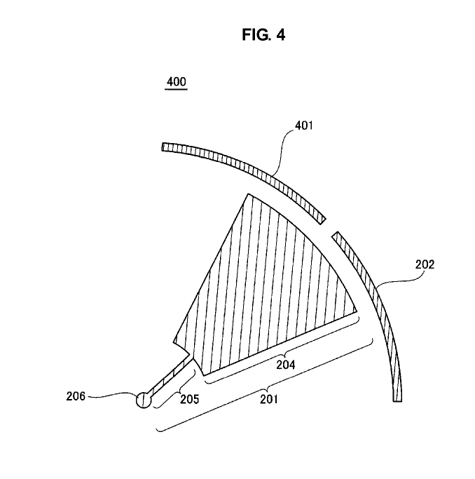

An upper surface view of the mechanical shutter 400 used in the pixel 106 of the display device related to embodiment two of the present invention is shown in FIG. 4. As is shown in FIG. 4, while the upper view of the mechanical shutter 400 is almost the same as that shown in FIG. 2 (a), a fixed electrode 401 is further arranged. In FIG. 4, the fixed electrode 401 also has a roughly round arc shape the same as the fixed electrode 202. In addition, in FIG. 4, the shape of the fixed electrode 401 is a round arc which has the same radius as the round arc which is the shape of the fixed electrode 202. In addition, in the present embodiment, it is possible to make the potential supplied to the fixed electrode 202 and the potential supplied to the fixed electrode 401 be different. For example, the fixed electrode 202 and the fixed electrode 401 may be connected to different data lines. In addition, in the case where a switching element is formed between the pixel 106 and a data line and a positive potential is supplied to the data line, the positive potential may be supplied to either the fixed electrode 202 or the fixed electrode 401, and in the case where a negative potential is supplied to the data line, the negative potential may be supplied to the other fixed electrode.

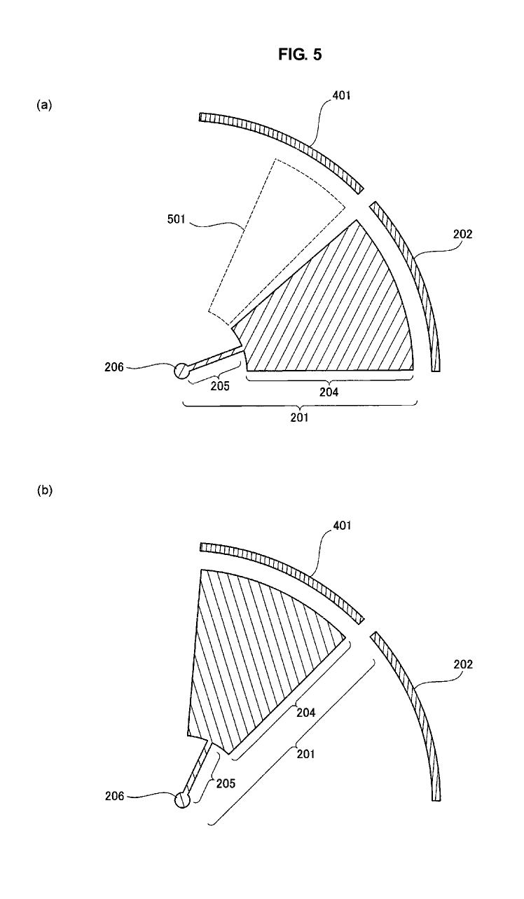

The movement of the mechanical shutter 400 is explained with reference to FIG. 5. It is assumed that the electrical attraction force which attracts the shutter 204 towards the fixed electrode 202 is larger than the electrical attraction force which attracts the shutter 204 towards the fixed electrode 401 by differentiating the potential supplied to the fixed electrode 202 and the potential supplied to the fixed electrode 401. For example, the potential supplied to the substrate connection part 206 and the potential supplied to the fixed electrode 401 is the same (a ground potential for example) and a positive potential is supplied to the fixed electrode 202.

In this case, an electrical attraction force which attracts the shutter 204 towards the fixed electrode 202 is applied to the shutter 204, and the beam 205 and/or the substrate connection part 206 undergo deformation. As a result, the shutter 204 moves in a clockwise direction as is shown in FIG. 5 (a) with the substrate connection part 206 as the center, and the shutter 204 stops at a position where the electrical attraction force and the force which attempts to restore the beam 205 and/or substrate connection part 206 to the state shown in FIG. 4 are balanced.

In addition, by making the potential supplied to the substrate connection part 206 and the potential supplied to the fixed electrode 202 the same (a ground potential for example), and supplying a positive potential to the fixed electrode 401, the electrical attraction force which attracts the shutter 204 towards the fixed electrode 401 becomes larger than the electrical attraction force which attracts the shutter 204 towards the fixed electrode 202. Then, the shutter 204 moves in the reverse direction to FIG. 5 (a), the shutter 204 moves in an anti-clockwise direction as is shown in FIG. 5 (b), and the shutter stops at a position where the electrical attraction force and the force which attempts to restore the beam 205 and/or substrate connection part 206 to the state shown in FIG. 4 are balanced.

Therefore, it is possible to arrange an aperture part 501 as follows. That is, it is possible to arrange the aperture part 501 on a part which is not covered by the shutter 204 in the state shown in FIG. 5 (a) seen from the upper surface of the substrate 111, and on a part of the substrate 111 which is covered by the shutter 204 in the state shown in FIG. 5 (b). In this way, it is possible to control the amount of light that passes through the aperture part 501.

In the present embodiment, because the fixed electrode 401 is further arranged, it is possible to further increase the amount by which the shutter 204 moves. In this way, it is possible to make the aperture part 501 in the present embodiment larger than the aperture part 301. Therefore, it is possible to pass more light through to each pixel and display a brighter image.

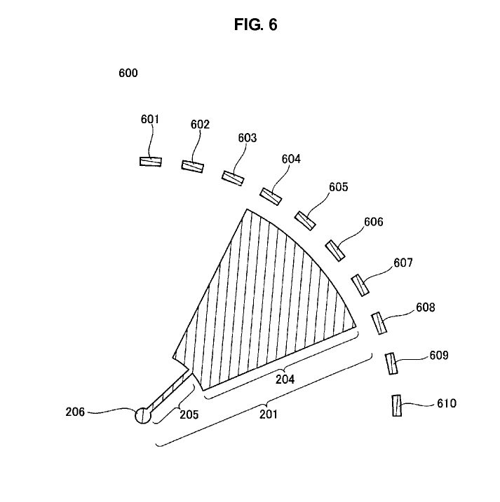

FIG. 6 shows a mechanical shutter 600 with more fixed electrodes than in FIG. 4 and FIG. 5. In FIG. 6, for example, ten fixed electrodes 601-610 are arranged so that they form a roughly round arc. However, the fixed electrodes may also be arranged on bent lines or one or more of curved lines other than a round arc. The fixed electrodes 601-610 may be arranged at equal intervals. In addition, control may be performed so that a different potential can be supplied to each of the fixed electrodes 601-610 respectively.

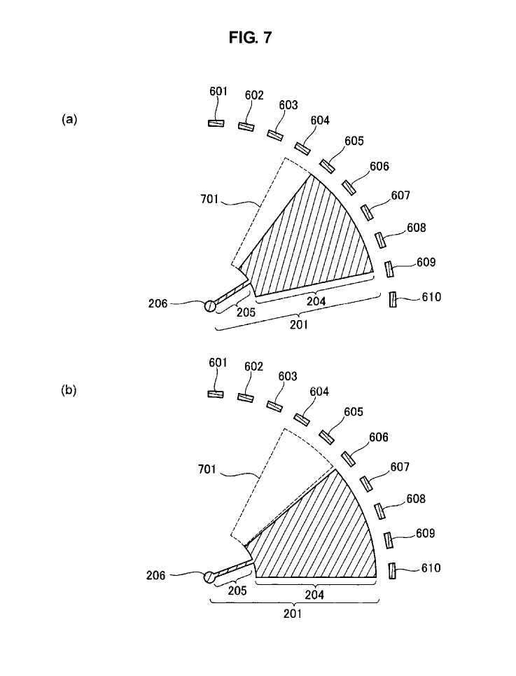

The movement of the shutter 600 in the case where different potentials are supplied to the fixed electrodes 601-610 is shown in FIG. 7. For example, the same potential is supplied to the substrate connection part 206, and the fixed electrodes 601-604, 610 (a ground potential for example) and different potentials are supplied to the fixed electrodes 605-609. Then, an electrical attraction force is produced which attracts the shutter 204 towards the fixed electrodes 605-609. As a result, the shutter 204 moves as is shown in FIG. 7 (a). In addition, for example when the same potential is supplied to the substrate connection part 206 and the fixed electrodes 601-605 (a ground potential for example), and different potentials are supplied to the fixed electrodes 606-610, the shutter further moves from the state shown in FIG. 7 (a) to the state shown in FIG. 7 (b).

Therefore, as is shown in FIG. 7, an aperture part 701 is arranged on the substrate 111 and it is possible to control the extent to which the shutter 204 covers the aperture part 701 by controlling the potential supplied to the fixed electrodes 601-610. Consequently, in the present embodiment, it is possible to control the amount of light which passes through the aperture part 701 according to the number and/or positions of fixed electrodes which are supplied with a potential different to a potential of the shutter 204.

### Embodiment Three

An embodiment is disclosed in which a plurality of apertures are arranged on the shutter 204 in the embodiments described above as embodiment three of the present invention.

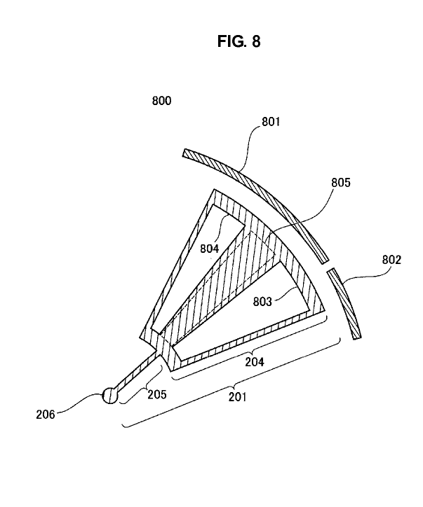

An upper surface view of a mechanical shutter 800 for in the pixel 106 of a display device related to embodiment three of the present invention is shown in FIG. 8. As is shown in FIG. 8, the mechanical shutter 800 includes a plurality of apertures 803 and 804 on the shutter 204. In addition, as is shown by the dotted line, an aperture part 805 is arranged at a position of the substrate 111 between the apertures 803 and 804 in the state where the beam 205 and substrate connection part 206 do not undergo deformation. In addition, the size of the aperture 803 and the size of the aperture 804 are different, for example, the aperture 803 is larger than the aperture 804. In addition, as in embodiment two, a plurality of fixed electrodes 801 and 802 are arranged and a control is possible so as to make the potential supplied to the fixed electrode 801 and the potential supplied to the fixed electrode 802 be different.

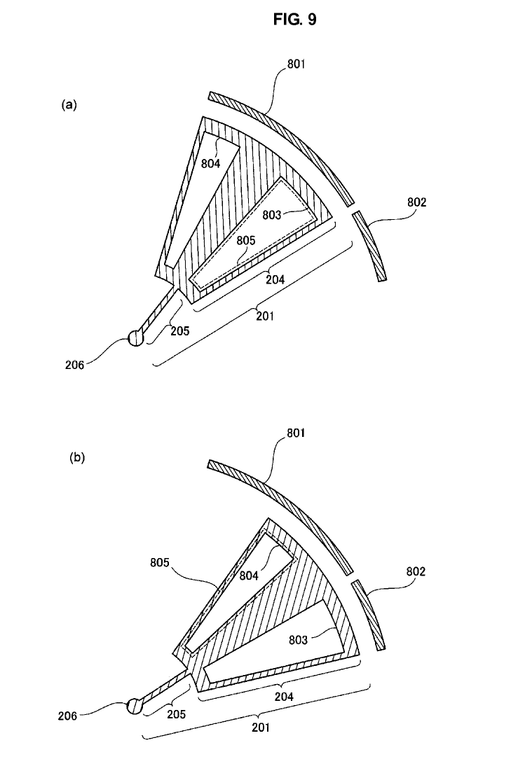

The movement of the mechanical shutter 800 is explained while referring to FIG. 9. It is possible to make the electrical attraction force which attracts the shutter 204 towards the fixed electrode 801 be larger than the electrical attraction force which attracts the shutter 204 towards the fixed electrode 802 by arranging a difference between the potential supplied to the fixed electrode 801 and the potential supplied to the fixed electrode 802.

In this case, a greater force than the electrical attraction force which attracts the shutter 204 towards the fixed electrode 801 is applied and the beam 205 and/or substrate connection force 206 undergo deformation. As a result, the shutter 204 rotates in an anti-clockwise direction as is shown in FIG. 9 (a) with the substrate connection part 206 at the center. As a result, the shutter 204 stops at a position where the electrical attraction force and the force which attempts to restore the beam 205 and/or the substrate connection part 206 to the state shown in FIG. 8 are balanced. In this way, it is possible to position the aperture 803, which is larger than the aperture 804, above the aperture part 805.

Alternatively, it is possible to make the force which attracts the shutter 204 towards the fixed electrode 802 be greater than the force which attracts the shutter 204 towards the fixed electrode 801. In this case, a force which attracts the shutter 204 towards the fixed electrode 802 is applied and the beam 205 and/or the substrate connection part 206 undergo deformation. As a result, the shutter 204 rotates in a clockwise direction as is shown in FIG. 9 (b) with the substrate connection part 206 as the center, and the shutter 204 stops at a position where the electrical attraction force and the force which attempts to restore the beam 205 and/or the substrate connection part 206 to the state shown in FIG. 8 are balanced. In this way, it is possible to position the aperture 804, which is smaller than the aperture 803, above the aperture part 805.

Therefore, because the amount of light which passes through the aperture 803 and the aperture 804 is different, a two level gradation of amount of transmittance light can be controlled. In addition, because it is possible to reduce the amount by which the shutter 204 moves, it is possible to more rapidly switch the display of an image.

Furthermore, in the present embodiment, while the case where two apertures are arranged on the shutter 204 is disclosed, transmittance light with an arbitrary number of gradations larger than two can be controlled by arranging an arbitrary number of apertures of three or more.

As described above, because a shutter is driven without using a contacting beam using the embodiments of the present invention, it is possible to provide a display device which controls the amount of light of each pixel using a shutter without using a process for forming an insulation film. In addition, a display device is also possible without generating a deterioration of a beam insulation film.

What is claimed is:

1. A display device comprising:
a plurality of data lines supplied with potentials via a data driver;
a plurality of gate lines supplied with a potential via a gate driver; and
a display part including a pixel element corresponding to an intersection point of one of the plurality of data lines and one of the plurality of gate lines on a substrate, said pixel element having:
a substrate connection part formed on the substrate;
a shutter including a light blocking part, the shutter being formed above the substrate;
a beam which connects the substrate connection part and a side surface of the light blocking part; and
an electrode formed on the substrate, said electrode being opposite to and separated from an exterior edge of the side surface of the shutter.

2. The display device according to claim 1 wherein a part of the electrode opposes a part of the exterior edge.

3. The display device according to claim 2 wherein a length of a part at which the electrode and the exterior edge oppose each other increases when a different potential is supplied to the exterior edge and the electrode.

4. The display device according to claim 1 wherein the beam undergoes deformation and the shutter moves in parallel to the substrate.

5. The display device according to claim 1 wherein the substrate connection part undergoes deformation and the shutter moves in parallel to the substrate.

6. The display device according to claim 1 wherein the pixel element further includes a second electrode formed on the substrate, a part of the second electrode being opposite to another part of the exterior edge

7. The display device according to claim 6 wherein it is possible to supply a different potential to the electrode and the second electrode.

8. The display device according to claim 7 wherein a length of a part at which the second electrode and the exterior edge oppose each other increases when a different potential is supplied to the exterior edge as well as the electrode and to the second electrode.

9. The display device according to claim 1 wherein the shutter includes a plurality of apertures.

10. The display device according to claim 9 wherein the size of the plurality of apertures are different.

11. A display device comprising:
a plurality of data lines supplied with potentials via a data driver;
a plurality of gate lines supplied with a potential via a gate driver; and
a display part including a pixel element corresponding to an intersection point of one of the plurality of data lines and one of the plurality of gate lines on a substrate, said pixel element including:
a substrate connection part formed on the substrate;
a shutter formed above the substrate, the shutter including a light blocking element, a first side surface, and an exterior edge arranged on an opposite side to the first side surface;
a beam which connects the substrate connection part and a side surface of the light blocking part; and
a plurality of electrodes formed on the substrate separated from the exterior edge.

12. The display device according to claim 11 wherein the plurality of electrodes are essentially arranged at equal intervals.

13. The display device according to claim 11 wherein the shutter moves and opposes an electrode which is supplied with a different potential to the exterior edge among the plurality of electrodes.

14. The display device according to claim 11 wherein the beam undergoes deformation and the shutter moves in parallel to the substrate.

15. The display device according to claim 11 wherein the substrate connection part undergoes deformation and the shutter moves in parallel to the substrate.

16. A display device comprising:
a plurality of data lines supplied with potentials via a data driver;
a plurality of gate lines supplied with a potential via a gate driver; and
a display part which includes a pixel element corresponding to an intersection point of one of the plurality of data lines and the plurality of gate lines on a substrate, said pixel element having:
a substrate connection part formed on the substrate;
a shutter formed above the substrate, the shutter including a light blocking element, a first side surface, an exterior edge arranged on an opposite side to the first side surface, and a plurality of apertures having different sizes on the light blocking part;
a beam which connects the substrate connection part and a side surface of the light blocking part; and
a plurality of electrodes formed on the substrate separated from the exterior edge.

17. The display device according to claim 16 wherein a length of the plurality of electrodes is different.

18. The display device according to claim 16 wherein the plurality of electrodes are essentially arranged at equal intervals.

19. The display device according to claim 18 wherein the plurality of electrodes is divided into a first group applied with a first potential, and a second group applied with a second potential.

20. The display device according to claim 19 wherein electrodes are continuously arranged in a line in each of the first group and the second group respectively.
